(19) United States
(12) Patent Application Publication
(10) Pub. No.: US 2001/0010718 A1
(43) Pub. Date: Aug. 2, 2001

(54) Telephone for a plurality of simultaneous conversations

(76) Inventors: Debbie Pinard, Kanata (CA); Douglas Oddy, Greely (CA)

Correspondence Address: MARKS & CLERK, P.O. Box 957, Station B, Ottawa, ON, KIP 587, CA

(21) Appl. No.: 09/764,458

(22) Filed: Jan. 19, 2001

(30) Foreign Application Priority Data
Jan. 29, 2000 (GB) 0001957.0

(51) Int. Cl. H04M 1/00; H04M 9/00

(52) U.S. Cl. 379/419; 379/428.01

(57) ABSTRACT

A system for receiving a plurality of telephone calls on a single base of a telephone set while allowing access to all of the calls simultaneously with each call being answered by a separate handset dedicated to a specific individual call. The system includes a plurality of handsets and indicators with each handset having its own indicator for indicating an incoming call.

### FIELD OF THE INVENTION

The present invention relates to a telephone system and method for permitting a plurality of conversations and more particularly, the present invention relates to a telephone having a plurality of handsets each for receiving a distinct call.

### BACKGROUND OF THE INVENTION

Generally, multiple line telephones have a series of discrete lines which are accessible on a one at a time basis with one handset. Accordingly, several users may have access to the same phone and thus use the same handset. For incoming calls the existing products permit one phone number or several different phone numbers on a given telephone set, but in all cases only one of the lines is accessible at any time, since one handset is connected to the telephone set base. This arrangement does not facilitate access to any one of the different lines simultaneously as another is selected. Accordingly, the existing sets, regardless of the number of lines, cannot allow many users simultaneously to each access a specific line on the same telephone set.

The present invention addresses this limitation in the art and provides a device capable of overcoming the shortcomings in the art.

### SUMMARY OF THE INVENTION

In accordance with one object of the present invention, there is provided a telephone set for handling a plurality of conversations simultaneously, comprising:

a single base having an internet protocol network interface adapted for connection with an internet protocol network for isolating a digitized information packet associated with a specific conversation;

a plurality of handsets connected with the base for receiving a specific information packet from the base; and

indication means for indicating which handset of the handsets is active.

The indication means may comprise any visual, audible or combination of these indicators. As a further possibility, the indicator may comprise a telephone set mounted and remote device having a vibration function wearable by a user to avoid confusion, several lights or rings during times when such interruptions would not be appropriate. This variation would simply alert the user to a call which could be responded to at a later time.

It will be evident that the individual handsets may be cordless and simply use the base as a main charge cradle/base station.

The invention takes advantage of the digitized packeting of the data on a LAN with the telephone set base providing many connections to a network interface. Such interfaces are well known in the art and therefore will not be elaborated upon here.

In accordance with a further object of the present invention, there is provided a communications system for handling a plurality of conversations simultaneously, comprising:

a local area network;

a single telephone base having an internet protocol network interface adapted for connection with an internet protocol network for isolating a digitized information packet associated with a specific conversation;

a plurality of handsets connected with the base for receiving a specific information packet from the base;

connection means for connecting the telephone base to a computer; and

indication means for indicating which handset of the handsets is active.

Having thus generally described the invention, reference will now be made to the accompanying drawings, illustrating preferred embodiments and, in which:

### BRIEF DESCRIPTION OF THE DRAWINGS

FIG. 1 is a block diagram of the system configuration; and

FIG. 2 is a perspective view of one embodiment of the present invention.

Similar numerals employed in the text denote similar elements.

### DETAILED DESCRIPTION OF THE PREFERRED EMBODIMENTS

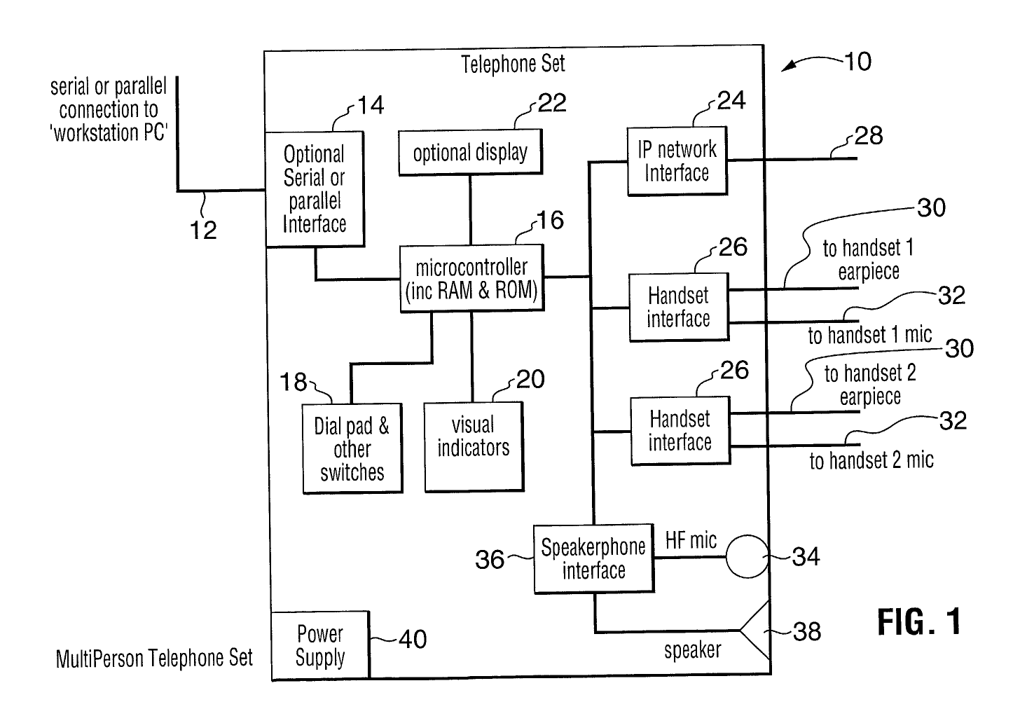

Referring to FIG. 1, shown is a block diagram of one embodiment of the present invention. The telephone set, broadly denoted by numeral 10, includes a connection port 12 for connection to a computer (not shown) and a serial or parallel interface 14 in turn connected to a microcontroller 16. The controller 16 connects a dial pad 18, visual indicators 20 and an optional display 22 in a known manner.

A network interface 24 is connected to controller 16 as are a plurality of handset interfaces 26. Interface 24 may be connected to a LAN in a known manner at connection site 28. The handset interfaces 26 include the conventional earpiece 30 and microphone ports 32. A speakerphone circuit having a microphone 34, interface 36 and speaker 38 are associated features of the set 10. A conventional power supply 40 completes the set 10.

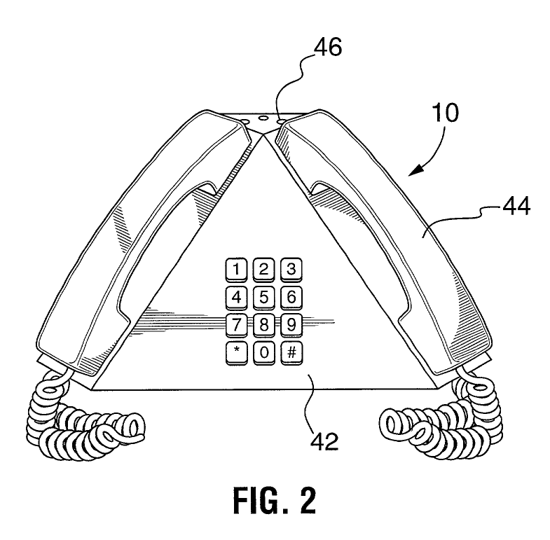

With reference to FIGS. 1 and 2, by providing a series of handset interfaces 26 in the set 10, the single base 42 illustrated in FIG. 2 may then permit several calls to be simultaneously processed each with its own handset 44 and specific indicator 46, shown in the example as lights.

Although embodiments of the invention have been described above, it is not limited thereto and it will be apparent to those skilled in the art that numerous modifications form part of the present invention insofar as they do not depart from the spirit, nature and scope of the claimed and described invention.

We claim:

1. A telephone set for handling a plurality of conversations simultaneously, comprising:
a single base having an internet protocol network interface adapted for connection with an internet protocol network for isolating a digitized information packet associated with a specific conversation;
a plurality of handsets connected with said base for receiving a specific information packet from said base; and
indication means for indicating which handset of said handsets is active.

2. The telephone set as set forth in claim 1, wherein said indication means comprises a plurality of different sounds, a specific sound associated with a specific handset.

3. The telephone set as set forth in claim 1, wherein said indication means comprises a visual indication of which of said handsets is active.

4. A communications system for handling a plurality of conversations simultaneously, comprising:
a local area network;
a single telephone base having an internet protocol network interface adapted for connection with an internet protocol network for isolating a digitized information packet associated with a specific conversation;
a plurality of handsets connected with said base for receiving a specific information packet from said base;
connection means for connecting said telephone base to a computer; and
indication means for indicating which handset of said handsets is active.

5. The system as set forth in claim 4, wherein said indication means comprises a plurality of different sounds, a specific sound associated with a specific handset.

6. The system as set forth in claim 4, wherein said indication means comprises a visual indication of which of said handsets is active.
